(19) United States
(12) Patent Application Publication
(10) Pub. No.: US 2025/0231539 A1
(43) Pub. Date: Jul. 17, 2025

(54) METHOD OF CONSTRUCTING AND PREDICTING POWER PREDICTION MODEL OF MULTI-ENERGY COMBINED POWER GENERATION SYSTEM

(71) Applicant: CHINA THREE GORGES CORPORATION, Wuhan, Hubei (CN)

(72) Inventors: Wei ZHANG, Wuhan, Hubei (CN); Mengjie LI, Wuhan, Hubei (CN); Lu ZHANG, Wuhan, Hubei (CN); Kangdi HUANG, Wuhan, Hubei (CN); Ruikuo LIU, Wuhan, Hubei (CN); Zhiwu LIU, Wuhan, Hubei (CN)

(73) Assignee: CHINA THREE GORGES CORPORATION, Wuhan, Hubei (CN)

(21) Appl. No.: 18/853,708

(22) PCT Filed: Aug. 17, 2023
(86) PCT No.: PCT/CN2023/113555

§ 371 Date: Oct. 2, 2024

(30) Foreign Application Priority Data
Aug. 31, 2022 (CN) 202211059975.2

(51) Int. Cl. G05B 19/042

(52) U.S. Cl. CPC G05B 19/042; G05B 2219/2639

(57) ABSTRACT

A method of constructing and predicting a power prediction model of a multi-energy combined power generation system is provided. The method includes the following steps: acquiring historical generated power data and corresponding meteorological factors of each power generation mode in the multi-energy combined power generation system, and inputting the historical generated power data and corresponding meteorological factors into a preset network model to calculate the generated power correlation between any two of a plurality of power generation modes; constructing a loss function using the correlation and a Nash-Sutcliffe efficiency coefficient corresponding to each power generation mode, and using the historical generated power data of each power generation mode and the meteorological factors corresponding to the historical generated power data as training data, training the preset network model until preset training conditions are met and the corresponding power prediction model of the multi-energy combined power generation system is obtained.

### TECHNICAL FIELD

The present disclosure relates to the technical field of electric energy, and in particular to a method of constructing and predicting a power prediction model of a multi-energy combined power generation system.

### BACKGROUND

The vigorous development of the power generation technology of renewable energy sources such as hydraulic energy, wind energy and light energy can effectively solve the environmental pollution problems resulted from conventional fossil energy power generation. From the perspective of the current resource status and technical development level of renewable energy sources, it is an effective way to form a multi-energy complementary power generation system by polymerizing various renewable energy sources such as hydraulic energy, wind energy and solar energy. However, the randomness and fluctuation of photovoltaic power generation and wind power generation are inherent defects of these two renewable energy sources, and large-scale grid connection of photovoltaic power generation and wind power generation will inevitably pose a threat to the safe and stable operation of a power generation system. Therefore, it is of great significance for the safe and stable operation of the power generation system, the improvement of the power quality and the improvement of the effective utilization of renewable energy to improve the precision of combined power generation prediction of various renewable energy sources. However, most of the existing generated power prediction of renewable energy sources analyzes a single energy source with the help of artificial intelligence algorithms such as deep learning. However, combined power prediction has not been carried out based on various renewable energy sources.

### SUMMARY

In view of this, the embodiment of the present disclosure provides a method of constructing and predicting a power prediction model of a multi-energy combined power generation system, so as to realize the combined prediction of various renewable energy sources.

The technical solution proposed by the present invention is as follows:

The first aspect of the present embodiment provides a method of constructing a power prediction model of a multi-energy combined power generation system, comprising the following steps:
acquiring historical generated power data of each power generation mode in the multi-energy combined power generation system and meteorological factors corresponding to the historical generated power data, wherein the meteorological factors characterize meteorological aspects affecting generated power;
inputting the historical generated power data of each power generation mode and the meteorological factors corresponding to the historical generated power data into a preset network model, so that the preset network model calculates the generated power correlation between any two of a plurality of power generation modes according to a preset correlation calculation method;
using a loss function constructed by the generated power correlation between any two power generation modes and a Nash-Sutcliffe efficiency coefficient corresponding to each power generation mode as an objective function, and using the historical generated power data of each power generation mode and the meteorological factors corresponding to the historical generated power data as training data, training the preset network model until preset training conditions are met and the corresponding power prediction model of the multi-energy combined power generation system is obtained.

Optionally, prior to inputting the historical generated power data of each power generation mode and the meteorological factors corresponding to the historical generated power data into a preset network model, the method further comprises:
carrying out identification operation of abnormal data and/or missing data on the acquired historical generated power data;
carrying out abnormal processing on the historical generated power abnormal data and the historical generated power missing data which have been identified.

Optionally, carrying out identification operation of missing data on the acquired historical generated power data comprises:
when a time interval corresponding to any two adjacent acquired historical generated power data is longer than a preset duration, judging that the two adjacent historical generated power data are historical generated power missing data.

Optionally, carrying out abnormal processing on the historical generated power abnormal data and the historical generated power missing data which have been identified comprises:
deleting the historical generated power missing data from the acquired historical generated power data and processing the historical generated power abnormal data by using a preset supervised learning method.

Optionally, the multi-energy combined power generation system comprises a hydropower generation system.

Optionally, acquiring historical generated power data of each power generation mode in the multi-energy combined power generation system comprises:
acquiring historical data of a hydropower station and calculating corresponding hydropower historical generated power data according to the historical data of the hydropower station.

The second aspect of the present embodiment provides a method of predicting power of a multi-energy combined power generation system, comprising the following steps:
acquiring meteorological factors corresponding to generated power data of each power generation mode in the multi-energy combined power generation system to be predicted;
inputting the meteorological factors corresponding to the generated power data of each power generation mode into a power prediction model of the multi-energy combined power generation system constructed by the method of constructing the power prediction model of the multi-energy combined power generation system according to any one of claims 1 to 6 to obtain the power of the multi-energy combined power generation system to be predicted.

The third aspect of the present embodiment provides a device of constructing a power prediction model of a multi-energy combined power generation system, comprising:
a first acquisition module, which is configured to acquire historical generated power data of each power generation mode in the multi-energy combined power generation system and meteorological factors corresponding to the historical generated power data, wherein the meteorological factors characterize meteorological aspects affecting generated power;
a first input module, which is configured to input the historical generated power data of each power generation mode and the meteorological factors corresponding to the historical generated power data into a preset network model, so that the preset network model calculates the generated power correlation between any two of a plurality of power generation modes according to a preset correlation calculation method;
a training module, which is configured to, using a loss function constructed by the generated power correlation between any two power generation modes and a Nash-Sutcliffe efficiency coefficient corresponding to each power generation mode as an objective function, and using the historical generated power data of each power generation mode and the meteorological factors corresponding to the historical generated power data as training data, train the preset network model until preset training conditions are met and the corresponding power prediction model of the multi-energy combined power generation system is obtained.

The fourth aspect of the present embodiment provides a device of predicting power of a multi-energy combined power generation system, comprising:
a second acquisition module, which is configured to acquire meteorological factors corresponding to generated power data of each power generation mode in the multi-energy combined power generation system to be predicted;
a second input module, which is configured to input the meteorological factors corresponding to the generated power data of each power generation mode into a power prediction model of the multi-energy combined power generation system constructed by the method of constructing the power prediction model of the multi-energy combined power generation system to obtain the power of the multi-energy combined power generation system to be predicted.

A fifth aspect of the embodiment of the present disclosure provides a computer-readable storage medium, in which computer instructions are stored, and the computer instructions allow the computer to implement the method of constructing the power prediction model of the multi-energy combined power generation system according to a first aspect and any one of the first aspects of the embodiment of the present disclosure, or the method of predicting power of the multi-energy combined power generation system according to a second aspect or any one of the second aspects of the embodiment of the present disclosure.

A sixth aspect of the embodiment of the present disclosure provides an electronic device, which includes a memory and a processor, wherein the memory and the processor are in communication with each other, the memory stores computer instructions, and the processor executes the computer instructions, so as to implement the method of constructing the power prediction model of the multi-energy combined power generation system according to a first aspect and any one of the first aspects of the embodiment of the present disclosure, or the method of predicting power of the multi-energy combined power generation system according to a second aspect or any one of the second aspects of the embodiment of the present disclosure.

The technical scheme provided by the present disclosure has the following effects:

According to the method of constructing the power prediction model of the multi-energy combined power generation system provided by the embodiment of the present disclosure, a loss function consisted of the Nash-Sutcliffe efficiency coefficient and the generated power correlation is constructed, which takes into account the demand for improving the precision of predicting the model and the correlation of power prediction of the multi-energy combined power generation system, and provides basic and accurate data support for the preparation of a multi-energy complementary dispatching plan.

According to the method of predicting power of the multi-energy combined power generation system provided by the embodiment of the present disclosure, the trained power prediction model of the multi-energy combined power generation system is used for prediction, and the synchronized and combined prediction of the power of the multi-energy combined power generation system is realized.

### BRIEF DESCRIPTION OF THE DRAWINGS

In order to explain the specific embodiments of the present disclosure or the technical schemes in the prior art more clearly, the drawings needed in the description of the specific embodiment or the prior art will be briefly introduced hereinafter. Obviously, the drawings in the following description are only some embodiments of the present disclosure. For those skilled in the art, other drawings can be obtained according to these drawings without creative labor.

FIG. 1 is a flowchart of a method of constructing a power prediction model of a multi-energy combined power generation system according to an embodiment of the present disclosure.

FIG. 2 is a schematic diagram of a box plot according to an embodiment of the present disclosure.

FIG. 3 is a flowchart of a method of predicting power of a multi-energy combined power generation system according to an embodiment of the present disclosure.

FIG. 4 is a structural block diagram of a device of constructing a power prediction model of a multi-energy combined power generation system according to an embodiment of the present disclosure.

FIG. 5 is a structural block diagram of a device of predicting power of a multi-energy combined power generation system according to an embodiment of the present disclosure.

FIG. 6 is a schematic structural diagram of a computer-readable storage medium according to an embodiment of the present disclosure.

FIG. 7 is a schematic structural diagram of an electronic device according to an embodiment of the present disclosure.

### DETAILED DESCRIPTION OF THE EMBODIMENTS

In order to make the purpose, the technical scheme and the advantages of the present disclosure more clear, the technical schemes in the embodiments of the present disclosure will be clearly and completely described with reference to the drawings in the embodiments of the present disclosure hereinafter. Obviously, the described embodiments are only some embodiments of the present disclosure, rather than all of the embodiments. Based on the embodiments of the present disclosure, all other embodiments obtained by those skilled in the art without creative labor fall within the scope of protection of the present disclosure.

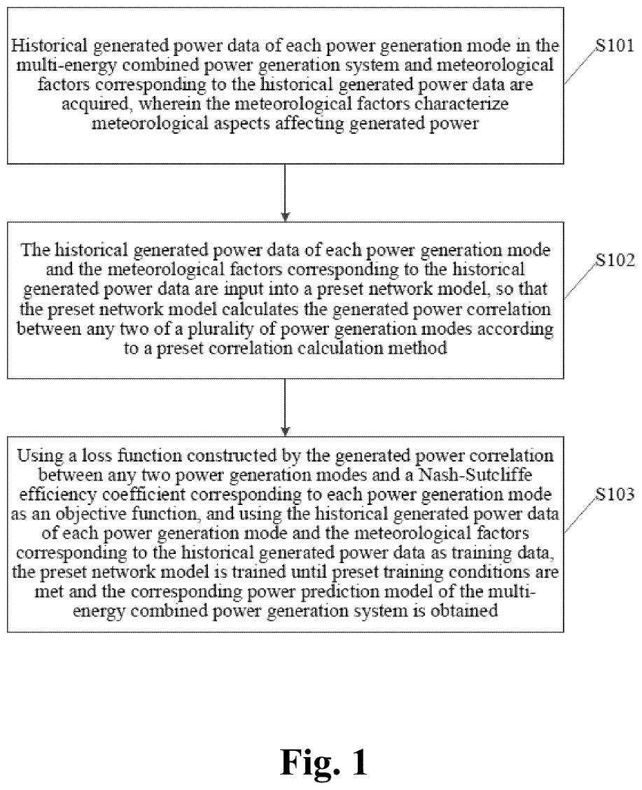

An embodiment of the present disclosure provides a method of constructing a power prediction model of a multi-energy combined power generation system, as shown in FIG. 1, including the following steps.

Step S101: historical generated power data of each power generation mode in the multi-energy combined power generation system and meteorological factors corresponding to the historical generated power data are acquired, wherein the meteorological factors characterize meteorological aspects affecting generated power. Specifically, the multi-energy combined power generation system refers to a power generation system that uses the complementarity between various energy sources. Taking the multi-energy combined power generation system including such as hydraulic energy, wind energy and solar energy as an example, the meteorological factors corresponding to the historical generated power data of each power generation mode of the system may include meteorological elements, such as precipitation, evaporation, runoff, air pressure, wind speed, wind direction, direct radiation, scattered radiation and temperature, which affect the generated power. The embodiment of the present disclosure does not limit the type of the meteorological factors, and those skilled in the art can select the meteorological factors that can affect the generated power according to the actual needs.

Step S102: the historical generated power data of each power generation mode and the meteorological factors corresponding to the historical generated power data are input into a preset network model, so that the preset network model calculates the generated power correlation between any two of a plurality of power generation modes according to a preset correlation calculation method. Specifically, the preset network model can be a neural network model such as a long short-term memory neural network (LSTM) model, which is not specifically limited by the present disclosure as long as it meets the demands.

The preset network model in the embodiment of the present disclosure carried out correlation calculation by the following formula:

$$r = \frac{{\sum }_{i = 1}^{n} ( {y}_{1 ( i )} - {\overline{y}}_{1} ) ( {y}_{2 ( i )} - {\overline{y}}_{2} )}{\sqrt{{\sum }_{i = 1}^{n} {( {y}_{1 ( i )} - {\overline{y}}_{1} )}^{2}} \sqrt{{\sum }_{i = 1}^{n} {( {y}_{2 ( i )} - {\overline{y}}_{2} )}^{2}}} \qquad ( 1 )$$

where r denotes the generated power correlation between two different power generation modes (y₁, y₂); n denotes the total number of samples of the historical generated power data of each power generation mode; y₁₍ᵢ₎ and y₂₍ᵢ₎ denote the power data of the i-th sample in the historical generated power data of two different power generation modes, respectively; y₁ and y₂ denote the average values of the historical generated power data of two different power generation modes, respectively.

After the preset network model learns the correlation calculation method, and after the historical generated power data of a plurality of power generation modes and the meteorological factors corresponding to the historical generated power data are input into the model, the preset network model can calculate the generated power correlation between any two of a plurality of power generation modes.

Step S103: using a loss function constructed by the generated power correlation between any two power generation modes and a Nash-Sutcliffe efficiency coefficient corresponding to each power generation mode as an objective function, and using the historical generated power data of each power generation mode and the meteorological factors corresponding to the historical generated power data as training data, the preset network model is trained until preset training conditions are met and the corresponding power prediction model of the multi-energy combined power generation system is obtained. The Nash-Sutcliffe efficiency coefficient is used to verify the simulation results of the model.

Specifically, first, the Nash-Sutcliffe efficiency coefficient (NSE) corresponding to each power generation mode is calculated by the following formula:

$$NSE = 1 - \frac{{\sum }_{t = 1}^{T} {( {y}_{1 ( t )} - {y}_{1 ( t )}^{f} )}^{2}}{{\sum }_{t = 1}^{T} {( {y}_{1 ( i )} - {\overline{y}}_{1} )}^{2}} \qquad ( 2 )$$

where T denotes the total number of samples of the historical generated power data of each power generation mode for model training, such as the total number of samples of 70% of the historical generated power data of each power generation mode; y₁₍ₜ₎ denotes the power data of the t-th sample in the historical generated power data of each power generation mode for model training; y₁₍ₜ₎ denotes the predicted power data of the t-th sample in the historical generated power data of each power generation mode for model training. The Nash-Sutcliffe efficiency coefficient can be calculated by comparing the actually acquired generated power data y₁₍ₜ₎ with the predicted power data y₁₍ₜ₎^{f}, which can verify the prediction results of the model.

Thereafter, the following loss function is constructed according to the generated power correlation between any two power generation modes of the multi-energy combined power generation system and the Nash-Sutcliffe efficiency coefficient corresponding to each power generation mode. Taking the multi-energy combined power generation system containing three power generation modes as an example, the calculation formula of the loss function is as follows:

$$L = {loss}_{NSE} + {loss}_{r} \qquad ( 3 )$$

where loss_{NSE} denotes the loss function corresponding to the Nash-Sutcliffe efficiency coefficient; and lossᵣ denotes the loss function corresponding to the generated power correlation between any two power generation modes;
wherein:

$${loss}_{NSE} = 3 - ( {NSE}_{1} + {NSE}_{2} + {NSE}_{3} ) \qquad ( 4 )$$

$${loss}_{r} = {λ}_{12} \vert {\hat{r}}_{12} - {r}_{12} \vert + {λ}_{13} \vert {\hat{r}}_{13} - {r}_{13} \vert + {λ}_{23} \vert {\hat{r}}_{23} - {r}_{23} \vert \qquad ( 5 )$$

where NSE₁, NSE₂ and NSE₃ denote the Nash-Sutcliffe efficiency coefficients corresponding to different power generation modes, respectively, and are calculated with reference to Formula (2); r₁₂, r₁₃ and r₂₃ denote the generated power correlation between any two power generation modes input by the model, respectively, and are calculated from the historical generated power, where r₁₂ denotes the generated power correlation between power generation mode 1 and power generation mode 2, r₁₃ denotes the generated power correlation between power generation mode 1 and power generation mode 3, and r₂₃ denotes the generated power correlation between power generation mode 2 and power generation mode 3; r₁₂, r₁₃ and r₂₃ denote the generated power correlation between any two corresponding power generation modes output by the model, respectively, and are calculated from the predicted generated power. Specifically, r₁₂, r₁₃, r₂₃, r₁₂, r₁₃ and r₂₃ are calculated with reference to Formula (1).

λ₁₂, λ₁₃ and λ₂₃ denote the corresponding penalty parameters of |\hat{r}₁₂−r₁₂|, |\hat{r}₁₃−r₁₃| and |\hat{r}₂₃−r₂₃|, respectively, and their values are as follows:

$${λ}_{12} = \{ \begin{matrix}1 , & others \\ {10}^{3} , & \vert {\hat{r}}_{12} \vert < \vert {r}_{12} \vert and \vert \frac{{\hat{r}}_{12} - {r}_{12}}{{r}_{12}} \vert > {α}_{r}\end{matrix} \qquad ( 6 )$$

$${λ}_{13} = \{ \begin{matrix}1 , & others \\ {10}^{3} , & \vert {\hat{r}}_{13} \vert < \vert {r}_{13} \vert and \vert \frac{{\hat{r}}_{13} - {r}_{13}}{{r}_{13}} \vert > {α}_{r}\end{matrix} \qquad ( 7 )$$

$${λ}_{23} = \{ \begin{matrix}1 , & others \\ {10}^{3} , & \vert {\hat{r}}_{23} \vert < \vert {r}_{23} \vert and \vert \frac{{\hat{r}}_{23} - {r}_{23}}{{r}_{23}} \vert > {α}_{r}\end{matrix} \qquad ( 8 )$$

where αᵣ denotes a relative difference threshold of the correlation between the historical generated power and the predicted generated power, which ranges from [0.1, 0.3]. The specific value needs to be further determined according to the preference of decision makers.

Training the model using the constructed loss function: using the historical generated power data of each power generation mode and the meteorological factors corresponding to the historical generated power data as training data, the preset network model is trained until the loss function takes the minimum value (Lₘᵢₙ), and the corresponding power prediction model of the multi-energy combined power generation system is obtained.

In an embodiment, when the multi-energy combined power generation system includes three different power generation modes (modes 1, 2 and 3), the preset network models are three different LSTM models, and the corresponding loss functions are all the loss functions described in Formula 3. After inputting the historical generated power data of the three power generation modes into the corresponding LSTM model for training, the power prediction model {LSTM₁, LSTM₂, LSTM₃} of the multi-energy combined power generation system is obtained. The power prediction model of the multi-energy combined power generation system consists of three trained power prediction models LSTM₁, LSTM₂ and LSTM₃ which are used to predict the power data corresponding to different power generation modes, respectively.

As a preferable implementation of the embodiment of the present disclosure, the parameters of the power prediction model of the multi-energy combined power generation system can also be optimized.

Specifically, when the multi-energy combined power generation system includes three different power generation modes (modes 1, 2 and 3), the hyper-parameters corresponding to the power prediction model of the multi-energy combined power generation system may include: the number of memory cells {MC₁, MC₂, MC₃}, the number of network layers {La₁, La₂, La₃}, the learning rate {R₁, R₂, R₃}, the batch size {B₁, B₂, B₃}, the number of time expansion steps {ts₁, ts₂, ts₃}, and the selection of the gradient descent algorithm {G₁, G₂, G₃}.

Given a set of hyper-parameters, respectively, the training set (70% of the historical generated power data from the historical generated power data) is used to train the power generation prediction models LSTM₁, LSTM₂ and LSTM₃ corresponding to the three different power generation modes, and the remaining 30% of the historical generated power data is used as the verification set to calculate the value of the corresponding objective function at this time.

The hyper-parameter combination of the generated power prediction model corresponding to each power generation mode when the objective function is minimum is acquired, and finally, the power prediction model {LSTM_{1(best)}, LSTM_{2(best)}, LSTM_{3(best)}} of the optimal multi-energy combined power generation system corresponding to the hyper-parameter combination.

According to the method of constructing the power prediction model of the multi-energy combined power generation system provided by the embodiment of the present disclosure, a loss function consisted of the Nash-Sutcliffe efficiency coefficient and the generated power correlation is constructed, which takes into account the demand for improving the precision of predicting the model and the correlation of power prediction of the multi-energy combined power generation system, and provides basic and accurate data support for the preparation of a multi-energy complementary dispatching plan.

As a preferable implementation of the embodiment of the present disclosure, prior to Step S102, the method further includes: carrying out identification operation of abnormal data and/or missing data on the acquired historical generated power data; and carrying out abnormal processing on the historical generated power abnormal data and the historical generated power missing data which have been identified.

First, the abnormal data in the historical generated power data are identified and processed by a box plot.

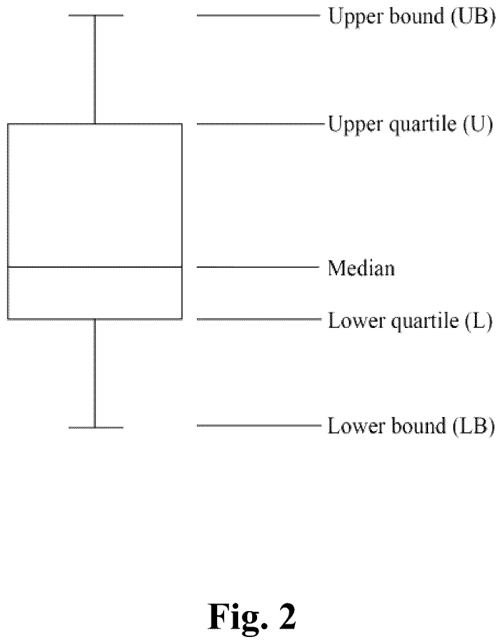

Specifically, using the box plot to identify abnormal data means that the data larger or smaller than the upper bound (UB) and the lower bound (LB) set by the box plot are regarded as abnormal data. The box plot is shown in FIG. 2.

The calculation formulas of UB and LB are:

$$UB = U + 1.5 ( U - L ) \qquad ( 9 )$$

$$LB = L - 1.5 ( U - L ) \qquad ( 10 )$$

where U is an upper quartile, indicating that only ¼ of the data in the historical generated power data corresponding to a certain power generation mode is greater than U; and L is a lower quartile, indicating that only ¼ of the data in the historical generated power data corresponding to a certain power generation mode is less than U.

Second, carrying out identification operation of missing data on the acquired historical generated power data includes: when a time interval corresponding to any two adjacent acquired historical generated power data is longer than a preset duration, judging that the two adjacent historical generated power data are historical generated power missing data. For example, data missing for more than 16 consecutive moments in the historical generated power data is regarded as historical generated power missing data.

Thereafter, carrying out abnormal processing on the historical generated power abnormal data and the historical generated power missing data which have been identified includes: deleting the historical generated power missing data from the acquired historical generated power data and processing the historical generated power abnormal data by using a preset supervised learning method.

The preset supervised learning method may include a K nearest neighbor complementary method, Naive Bayes, a decision tree, an EM algorithm, etc., which is not specifically limited by the present disclosure as long as it meets the demands.

Specifically, the historical generated power missing data is deleted from the historical generated power data.

In an embodiment, the calculation formula of processing the historical generated power abnormal data by using the K nearest neighbor complementary method is:

$${x}_{j} = \frac{{x}_{j - k} + … + {x}_{j - 1} + {x}_{j + 1} + … + {x}_{j + k}}{2 k} \qquad ( 11 )$$

where xⱼ indicates that the data of the j-th sample in the historical generated power data corresponding to a certain power generation mode is abnormal data xⱼ; xⱼ₋ₖ denotes the k-th data before xⱼ; xⱼ₊ₖ denotes the k-th data after xⱼ; generally, the value of k is 2-5, which can be determined according to the actual demand.

As a preferable implementation of the embodiment of the present disclosure, when the multi-energy combined power generation system is a multi-energy complementary combined power generation system of water, wind and light, acquiring historical generated power data of each power generation mode in the multi-energy combined power generation system includes: acquiring historical data of a hydropower station and calculating corresponding hydropower historical generated power data according to the historical data of the hydropower station. The historical data of the hydropower station include, but are not limited to, the inflow, the water level-storage capacity curve, the discharged volume-tail water level curve, the upper and lower limits of the water level of a hydropower station and a reservoir, the maximum power generation flow value of a hydropower station and a reservoir, the minimum allowable discharged volume, the output coefficient of a hydropower station, the installed capacity of a hydropower station, the guaranteed output of a hydropower station, and the dispatching regulations of a hydropower station.

Thereafter, the corresponding hydropower historical generated power data is calculated through the following formula:

$${P}_{t} = min ( {P}_{max} , η {QE}_{t} Δ {Z}_{t} ) \qquad ( 13 )$$

where Pₘₐₓ denotes the installed capacity; η denotes the output coefficient; QEₜ denotes the power generation flow of a hydropower station, which is the smaller value of the maximum allowable power generation flow QEₘₐₓ and the outflow Qₜ; ΔZₜ denotes the power generation head difference;
wherein:

$$Δ {Z}_{t} = {Z}_{t}^{up} - {Z}_{t}^{down} \qquad ( 14 )$$

$${Z}_{t}^{up} = f ( \frac{{V}_{t} + {V}_{t + 1}}{2} ) \qquad ( 15 )$$

$${Z}_{t}^{down} = g ( {Q}_{t} ) \qquad ( 16 )$$

$${V}_{t + 1} = {V}_{t} + ( {I}_{t} - {Q}_{t} ) Δ t \qquad ( 17 )$$

where Zₜ^{up} denotes the upstream water level, which is calculated according to the current average storage capacity and the water level-storage capacity curve Z^{up}˜f(V) of a hydropower station; Zₜ^{down} denotes the tail water level, which is calculated according to the current outflow Qₜ and the tail water level-discharged volume curve Z^{down}˜g(Q) of a hydropower station; Vₜ₊₁ denotes the storage capacity value of the t+1-th time period; Vₜ denotes the storage capacity value of the t-th time period; It denotes the inflow; Qₜ denotes the outflow, which can be calculated according to the dispatching regulation or the established dispatching scheme Qₜ=f(θₜ, Iₜ, Vₜ); wherein the parameter θₜ={θ_{1,t}, . . . , B_{M,t}} of the hydropower station scheduling scheme depends on the research object, the description type of the used scheduling rule and the presentation mode of the scheduling rule.

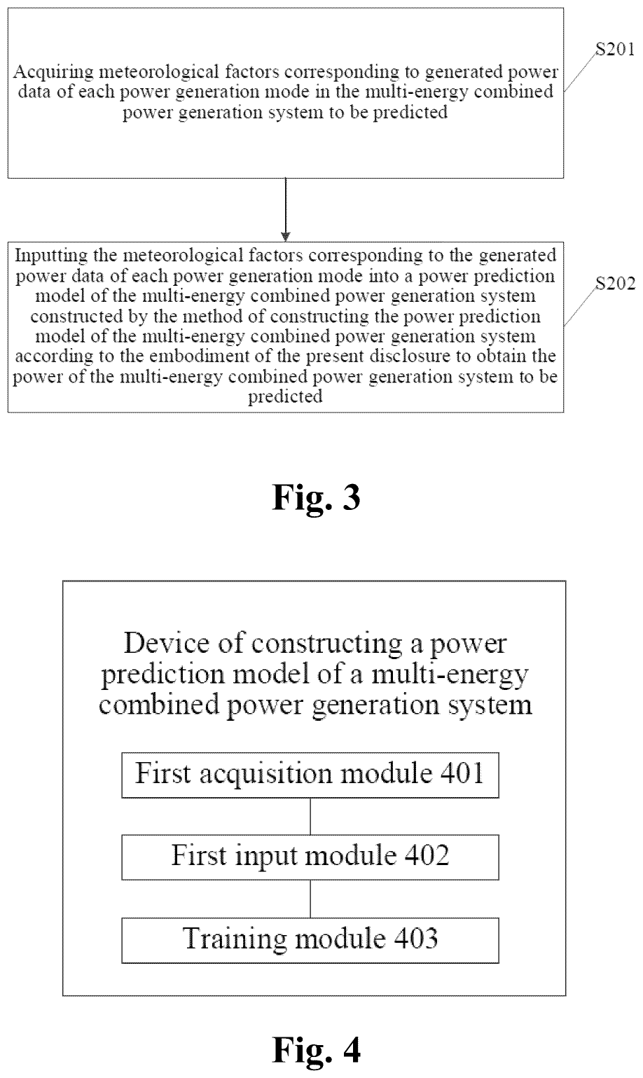

An embodiment of the present disclosure provides a method of predicting power of a multi-energy combined power generation system, as shown in FIG. 3, including the following steps:

Step S201: acquiring meteorological factors corresponding to generated power data of each power generation mode in the multi-energy combined power generation system to be predicted;

Step S202: inputting the meteorological factors corresponding to the generated power data of each power generation mode into a power prediction model of the multi-energy combined power generation system constructed by the method of constructing the power prediction model of the multi-energy combined power generation system according to the embodiment of the present disclosure to obtain the power of the multi-energy combined power generation system to be predicted. Specifically, the power of the multi-energy combined power generation system to be predicted can be acquired by using the trained power prediction model of the multi-energy combined power generation system.

In an embodiment, the meteorological factors of water, wind and light on the day to be predicted are input into the power prediction model {LSTM_{1(best)}, LSTM_{2(best)}, LSTM_{3(best)}} of the multi-energy combined power generation system, and the output {P₁, P₂, P₃} of the model is the final prediction result of the power of the water, wind and light combined power generation system.

According to the method of predicting power of the multi-energy combined power generation system provided by the embodiment of the present disclosure, the trained power prediction model of the multi-energy combined power generation system is used for prediction, and the synchronized and combined prediction of the power of the multi-energy combined power generation system is realized.

An embodiment of the present disclosure further provides a device of constructing a power prediction model of a multi-energy combined power generation system, as shown in FIG. 4, including:
a first acquisition module 401, which is configured to acquire historical generated power data of each power generation mode in the multi-energy combined power generation system and meteorological factors corresponding to the historical generated power data, wherein the meteorological factors characterize meteorological aspects affecting generated power; refer to the related description of Step S101 in the above method embodiment for details;
a first input module 402, which is configured to input the historical generated power data of each power generation mode and the meteorological factors corresponding to the historical generated power data into a preset network model, so that the preset network model calculates the generated power correlation between any two of a plurality of power generation modes according to a preset correlation calculation method; refer to the related description of Step S102 in the above method embodiment for details;
a training module 403, which is configured to, using a loss function constructed by the generated power correlation between any two power generation modes and a Nash-Sutcliffe efficiency coefficient corresponding to each power generation mode as an objective function, and using the historical generated power data of each power generation mode and the meteorological factors corresponding to the historical generated power data as training data, train the preset network model until preset training conditions are met and the corresponding power prediction model of the multi-energy combined power generation system is obtained; refer to the related description of Step S103 in the above method embodiment for details.

According to the device of constructing the power prediction model of the multi-energy combined power generation system provided by the embodiment of the present disclosure, a loss function consisted of the Nash-Sutcliffe efficiency coefficient and the generated power correlation is constructed, which takes into account the demand for improving the precision of predicting the model and the correlation of power prediction of the multi-energy combined power generation system, and provides basic and accurate data support for the preparation of a multi-energy complementary dispatching plan.

As a preferable implementation of the embodiment of the present disclosure, the device further includes: a first identifying module, which is configured to carry out identification operation of abnormal data and/or missing data on the acquired historical generated power data; and a first processing module, which is configured to carry out abnormal processing on the historical generated power abnormal data and the historical generated power missing data which have been identified.

As a preferable implementation of the embodiment of the present disclosure, the first identifying module includes: a first judgment sub-module, which is configured to judge that the two adjacent historical generated power data are historical generated power missing data when a time interval corresponding to any two adjacent acquired historical generated power data is longer than a preset duration.

As a preferable implementation of the embodiment of the present disclosure, the first processing module includes: a first processing sub-module, which is configured to delete the historical generated power missing data from the acquired historical generated power data and process the historical generated power abnormal data by using a preset supervised learning method.

As a preferable implementation of the embodiment of the present disclosure, the multi-energy combined power generation system includes a hydropower generation system.

As a preferable implementation of the embodiment of the present disclosure, the first acquisition module includes: a first calculation sub-module, which is configured to acquire historical data of a hydropower station and calculate corresponding hydropower historical generated power data according to the historical data of the hydropower station.

For the functional description of the device of constructing the power prediction model of the multi-energy combined power generation system provided by the embodiment of the present disclosure, refer to the description of the method of constructing the power prediction model of the multi-energy combined power generation system in the above embodiment for details.

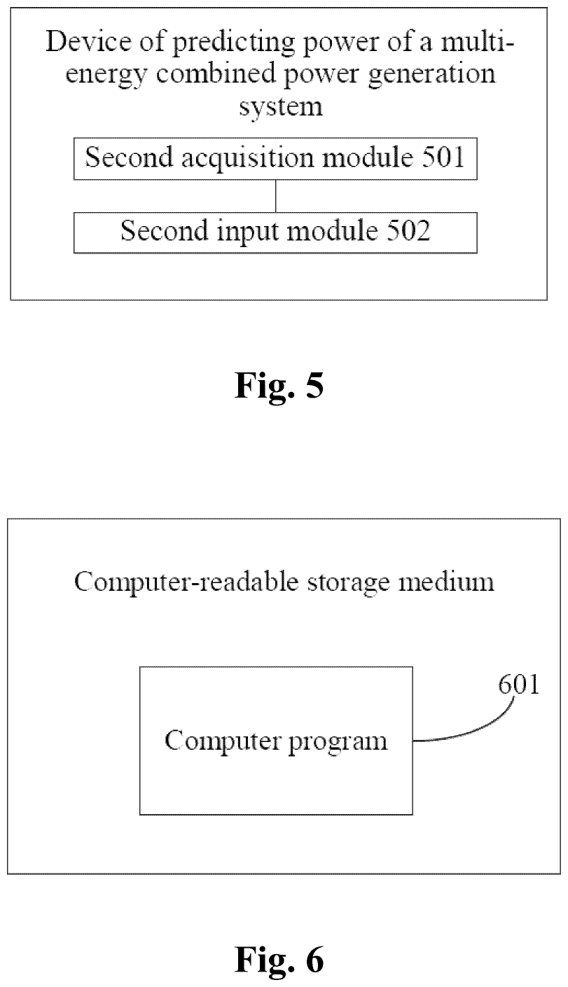

An embodiment of the present disclosure further provides a device of predicting power of a multi-energy combined power generation system, as shown in FIG. 5, which includes:
a second acquisition module 501, which is configured to acquire meteorological factors corresponding to generated power data of each power generation mode in the multi-energy combined power generation system to be predicted; refer to the related description of Step S201 in the above method embodiment for details;
a second input module 502, which is configured to input the meteorological factors corresponding to the generated power data of each power generation mode into a power prediction model of the multi-energy combined power generation system constructed by the method of constructing the power prediction model of the multi-energy combined power generation system according to the embodiment of the present disclosure to obtain the power of the multi-energy combined power generation system to be predicted; refer to the related description of Step S202 in the above method embodiment for details.

According to the device of predicting power of the multi-energy combined power generation system provided by the embodiment of the present disclosure, the trained power prediction model of the multi-energy combined power generation system is used for prediction, and the synchronized and combined prediction of the power of the multi-energy combined power generation system is realized.

For the functional description of the device of predicting power of the multi-energy combined power generation system provided by the embodiment of the present disclosure, refer to the description of the method of predicting power of the multi-energy combined power generation system in the above embodiment for details.

An embodiment of the present disclosure further provides a storage medium, as shown in FIG. 6, on which a computer program 601 is stored. The instruction, when executed by a processor, implements the steps of the method of constructing the power prediction model of the multi-energy combined power generation system or the method of predicting power of the multi-energy combined power generation system in the above embodiment. The storage medium can be a magnetic disk, an optical disk, a Read-Only Memory (ROM), a Random Access Memory (RAM), a Flash Memory, a Hard Disk Drive (HDD) or a Solid-State Drive (SSD). The storage medium may further include a combination of the above memories.

It can be understood by those skilled in the art that all or part of the processes in the methods of the above embodiments can be completed by instructing related hardware through a computer program. The program can be stored in a computer-readable storage medium. When executed, the program may include the processes of the embodiments of each method described above. The storage medium can be a magnetic disk, an optical disk, a Read-Only Memory (ROM), a Random Access Memory (RAM), a Flash Memory, a Hard Disk Drive (HDD) or a Solid-State Drive (SSD). The storage medium may further include a combination of the above memories.

The embodiment of the present disclosure further provides an electronic device, as shown in FIG. 7, which may include a processor 71 and a memory 72, wherein the processor 71 and the memory 72 may be connected by a bus or other means, and are connected by a bus as an example in FIG. 7.

The processor 71 may be a Central Processing Unit (CPU). The processor 71 can also be other general-purpose processors, Digital Signal Processors (DSP), Application Specific Integrated Circuits (ASIC), Field-Programmable Gate Arrays (FPGA) or other programmable logic devices, discrete gates or transistor logic devices, discrete hardware components and other chips, or a combination of the above chips.

As a non-transient computer-readable storage medium, the memory 72 can be used to store non-transient software programs, non-transient computer-executable programs and modules, such as corresponding program instructions/modules in the embodiment of the present disclosure. The processor 71 executes various functional applications and data processing of the processor by running non-transient software programs, instructions and modules stored in the memory 72, that is, the method of constructing the power prediction model of the multi-energy combined power generation system or the method of predicting power of the multi-energy combined power generation system in the above method embodiment is implemented.

The memory 72 may include a storage program area and a storage data area, wherein the storage program area may store an operating device and an application program required by at least one function. The storage data area may store data created by the processor 71 and the like. In addition, the memory 72 may include a high-speed random access memory and a non-transient memory, such as at least one of a disk storage device, a flash storage device, or other non-transient solid-state storage devices. In some embodiments, the memory 72 may preferably include a memory located remotely from the processor 71. These remote memories may be connected to the processor 71 through a network. Examples of the above networks include, but are not limited to, the Internet, an intranet, a local area network, a mobile communication network, and combinations thereof.

The one or more modules are stored in the memory 72, and when executed by the processor 71, implement the method of constructing the power prediction model of the multi-energy combined power generation system or the method of predicting power of the multi-energy combined power generation system in the embodiment shown in FIGS. 1 to 3.

The specific details of the above electronic device can be understood by referring to the corresponding related descriptions and effects in the embodiments shown in FIGS. 1 to 3, which will not be described in detail here.

1. A method of constructing a power prediction model of a multi-energy combined power generation system, comprising the following steps:
acquiring historical generated power data of each power generation mode in the multi-energy combined power generation system and meteorological factors corresponding to the historical generated power data, wherein the meteorological factors characterize meteorological aspects affecting generated power;
inputting the historical generated power data of each power generation mode and the meteorological factors corresponding to the historical generated power data into a preset network model, so that the preset network model calculates the generated power correlation between any two of a plurality of power generation modes according to a preset correlation calculation method;
using a loss function constructed by the generated power correlation between any two power generation modes and a Nash-Sutcliffe efficiency coefficient corresponding to each power generation mode as an objective function, and using the historical generated power data of each power generation mode and the meteorological factors corresponding to the historical generated power data as training data, training the preset network model until preset training conditions are met and the corresponding power prediction model of the multi-energy combined power generation system is obtained.

2. The method according to claim 1, wherein prior to inputting the historical generated power data of each power generation mode and the meteorological factors corresponding to the historical generated power data into a preset network model, the method further comprises:
carrying out identification operation of abnormal data and/or missing data on the acquired historical generated power data;
carrying out abnormal processing on the historical generated power abnormal data and the historical generated power missing data which have been identified.

3. The method according to claim 2, wherein carrying out identification operation of missing data on the acquired historical generated power data comprises:
when a time interval corresponding to any two adjacent acquired historical generated power data is longer than a preset duration, judging that the two adjacent historical generated power data are historical generated power missing data.

4. The method according to claim 2, wherein carrying out abnormal processing on the historical generated power abnormal data and the historical generated power missing data which have been identified comprises:
deleting the historical generated power missing data from the acquired historical generated power data and processing the historical generated power abnormal data by using a preset supervised learning method.

5. The method according to claim 1, wherein the multi-energy combined power generation system comprises a hydropower generation system.

6. The method according to claim 5, wherein acquiring historical generated power data of each power generation mode in the multi-energy combined power generation system comprises:
acquiring historical data of a hydropower station and calculating corresponding hydropower historical generated power data according to the historical data of the hydropower station.

7. A method of predicting power of a multi-energy combined power generation system based on the power prediction model according to claim 1, comprising the following steps:
acquiring meteorological factors corresponding to generated power data of each power generation mode in the multi-energy combined power generation system to be predicted;
inputting the meteorological factors corresponding to the generated power data of each power generation mode into the power prediction model of the multi-energy combined power generation system constructed by the method of constructing the power prediction model of the multi-energy combined power generation system to obtain the power of the multi-energy combined power generation system to be predicted.

8. A device of constructing a power prediction model of a multi-energy combined power generation system, comprising:
a first acquisition module, which is configured to acquire historical generated power data of each power generation mode in the multi-energy combined power generation system and meteorological factors corresponding to the historical generated power data, wherein the meteorological factors characterize meteorological aspects affecting generated power;
a first input module, which is configured to input the historical generated power data of each power generation mode and the meteorological factors corresponding to the historical generated power data into a preset network model, so that the preset network model calculates the generated power correlation between any two of a plurality of power generation modes according to a preset correlation calculation method;
a training module, which is configured to, using a loss function constructed by the generated power correlation between any two power generation modes and a Nash-Sutcliffe efficiency coefficient corresponding to each power generation mode as an objective function, and using the historical generated power data of each power generation mode and the meteorological factors corresponding to the historical generated power data as training data, train the preset network model until preset training conditions are met and the corresponding power prediction model of the multi-energy combined power generation system is obtained.

9. A device of predicting power of a multi-energy combined power generation system based on the power prediction model according to claim 1, comprising:
a second acquisition module, which is configured to acquire meteorological factors corresponding to generated power data of each power generation mode in the multi-energy combined power generation system to be predicted;
a second input module, which is configured to input the meteorological factors corresponding to the generated power data of each power generation mode into the power prediction model of the multi-energy combined power generation system constructed by the method of constructing the power prediction model of the multi-energy combined power generation system to obtain the power of the multi-energy combined power generation system to be predicted.
